(19) United States
(12) Patent Application Publication
(10) Pub. No.: US 2026/0173062 A1
(43) Pub. Date: Jun. 18, 2026

(54) METHOD FOR GUARANTEEING COMMUNICATION QUALITY OF EXISTING USER EQUIPMENT WHEN APPLYING AI/ML-BASED BEAM PREDICTION

(71) Applicant: KOREA RAILROAD RESEARCH INSTITUTE, Uiwang-si (KR)

(72) Inventors: Il Mu BYUN, Gunpo-si (KR); Jong Hun HAN, Gwacheon-si (KR); Sung Soo PARK, Uiwang-si (KR); Young Ju KIM, Yongin-si (KR); Seong Ho KWON, Seoul (KR)

(21) Appl. No.: 19/410,270

(22) Filed: Dec. 5, 2025

Related U.S. Application Data
(63) Continuation of application No. PCT/KR2025/018698, filed on Nov. 13, 2025.

(30) Foreign Application Priority Data
Dec. 17, 2024 (KR) 10-2024-0188629

(51) Int. Cl. H04W 72/044; H04W 24/02

(52) U.S. Cl. CPC H04W 72/046; H04W 24/02

(57) ABSTRACT

Embodiments relate to a method for ensuring communication quality of a conventional user equipment (UE) when applying AI/ML-based beam prediction. A method for operating a terminal in a wireless communication system includes receiving information for configuring cell parameters and acquiring at least one beam set associated with an AI/ML model based on the information for configuring the cell parameters. The information for configuring the cell parameters includes bitmap information and transmission interval information for the at least one beam set. According to one embodiment, even when AI/ML-based beam prediction technology is applied to reduce the overhead of SSB for beam sweeping, degradation of the existing UE performance can be minimized.

### CROSS-REFERENCE TO RELATED APPLICATION

This application is a continuation of International Application No. PCT/KR2025/018698 filed on Nov. 13, 2025, which claims priority to Korean Patent Application No. 10-2024-0188629, filed on Dec. 17, 2024, in the Korean Intellectual Property Office, the entire contents of which are herein incorporated by reference.

### BACKGROUND

### Field

The present invention relates to a method for guaranteeing the communication quality of an existing user equipment (UE) when applying AI/ML-based beam prediction, and more particularly, to a technology that can minimize performance degradation of an existing UE even when the overhead of synchronization signal blocks (SSBs) for beam sweeping is reduced by applying AI/ML-based beam prediction technology.

The 3rd Generation Partnership Project (3GPP) is currently discussing the application of beam management (BM) technology utilizing AI/ML (Artificial Intelligence/Machine Learning) to the New Radio (NR) air interface.

FIG. 1 is a conceptual diagram illustrating a beam management method using AI/ML according to the related art.

Among beam management technologies, BM-Case 1 and BM-Case 2 are under discussion. BM-Case 1 refers to a beam prediction technology performed in the spatial domain, while BM-Case 2 refers to a beam prediction technology performed in the time domain.

The objective of the beam prediction technology mainly discussed in the current standard is to reduce the overhead of the synchronization signal block (SSB) for beam sweeping. To achieve this, the number of SSBs in a continuously transmitted SSB burst is reduced through spatial beam prediction, and the transmission frequency of the SSB burst is decreased through temporal beam prediction.

FIG. 2A to 2C is a conceptual diagram illustrating the configuration of a beam set according to the related art.

FIG. 2A illustrates an example configuration of Set A and Set B of BM-Case 1, FIG. 2B illustrates an example of Case A of BM-Case 2, and FIG. 2C illustrates an example of Case B of BM-Case 2.

Both BM-Case 1 and BM-Case 2 define Set A and Set B for beam prediction. Set B is a set of beams that are used as inputs to an AI/ML model, and Set A is a set of beams that are output from the AI/ML model. Set A is a set of beams that includes all actual beams transmitted by a base station (gNB) in an SSB burst for beam scanning in an existing system where AI/ML is not used, while Set B is a set of beams defined to reduce the number of beams used for beam scanning in a system where AI/ML is applied. Therefore, the number (M) of beams in Set B is generally less than or equal to the number (N) of beams in Set A, but Set B is not necessarily a subset of Set A.

In BM-Case 1, the base station (gNB) transmits M SSB blocks within an SSB burst, thereby reducing the length of the SSB burst by (N-M) compared to the existing configuration. The user equipment (UE) that receives this executes an AI/ML model and selects Top-K beams having the highest received signal strength (RSRP) among the N beams of Set A. Therefore, in BM-Case 1, the number of beams in Set B must be smaller than that in Set A in order to reduce the SSB overhead.

BM-Case 2 can be divided into a method of increasing the SSB transmission period (Case B) and a method of temporarily stopping SSB transmission for a certain time (Case A). In Case A, the base station transmits SSB bursts at a period of Tper for a duration of T1, and then does not transmit SSB bursts for a duration of T2. During the T2 period, the UE or the base station performs beam prediction Pt times at intervals of Tper. The beams used in the SSB burst transmitted during the T1 period correspond to Set B, and during the T2 period, the UE or the base station selects Top-K beams from Set A using an AI/ML model. In Case A, the number (M) of beams in Set B may be less than or equal to the number (N) of beams in Set A.

In Case B, when the AI/ML model is not applied, the period at which the base station transmits an SSB is X ms, and when the AI/ML model is applied, the period is Y ms. In addition, when the AI/ML model is applied, the number of SSBs included in an SSB burst transmitted by the base station is M, and the number (M) of beams in Set B may be less than or equal to the number (N) of beams in Set A.

Since the current beam prediction technology aims to reduce resources for beam sweeping, performance degradation inevitably occurs. According to TR 38.843, a decrease in signal strength of at least 1-2 dB in L1-RSRP generally occurs, and in many cases, a reduction of up to 6 dB in L1-RSRP may occur.

In railways, vehicles, and smart factories, there are mobile UEs that require high-reliability communication for safety purposes. Therefore, it is necessary to determine whether to apply beam prediction depending on the location of the UE and whether safety-related traffic occurs. In addition, since existing UEs are expected to experience more severe performance degradation, a technique for minimizing the performance degradation of existing UEs is required.

Korean Patent Publication No. 10-2024-0058790, published on May 3, 2024, entitled “Method and Apparatus for Model Management in Beam Management Using Artificial Intelligence and Machine Learning,” discloses a method for predefining reference signal resources mapped to beam information in AI/ML model management, and dynamically transmitting and receiving appropriate reference signal resources depending on transitions of model, state, or scenario, thereby measuring a new beam set more quickly and efficiently. The disclosed method includes: receiving configuration information for one or more reference signal (RS) resource sets respectively corresponding to one or more AI/ML models or functionalities used for a specific purpose; receiving indication information for one selected reference signal resource set among the one or more reference signal resource sets; and measuring signal strength or signal quality of the reference signal based on the selected reference signal resource set.

(Prior Art 1) Korean Patent Publication No. 10-2024-0058790, “Method and Apparatus for Model Management in Beam Management Using Artificial Intelligence and Machine Learning,” published on May 3, 2024.

### SUMMARY

In 5G-Advanced, AI/ML-based beam prediction technology is being developed, and the purpose of the beam prediction technology is to reduce the overhead of a synchronization signal block (SSB) for beam sweeping. To achieve this, the transmission interval of an SSB burst is widened, or the number of beams within an SSB burst is reduced, which is expected to cause performance degradation of existing user equipment (UE).

In the case of railways or vehicles, the replacement cycle of UEs is long and safety-related information is handled; therefore, it is necessary to minimize performance degradation of existing UEs. Accordingly, the object of the present invention is to provide a method capable of minimizing the performance degradation of existing UEs, even when the overhead of SSBs for beam sweeping is reduced.

The problems to be solved by the present invention are not limited to the aforementioned problems, and other problems that are not mentioned will be clearly understood by those skilled in the art from the following description.

According to one aspect of the proposed invention, an operation method of a terminal in a wireless communication system includes: receiving information for configuring cell parameters; and acquiring at least one beam set associated with an AI/ML (artificial intelligence/machine learning) model based on the information for configuring the cell parameters. The information for configuring the cell parameters includes bitmap information and transmission interval information for the at least one beam set.

According to another aspect, the at least one beam set includes at least one first beam set associated with an input of the AI/ML model and at least one second beam set associated with an output of the AI/ML model.

According to another aspect, the bitmap information is configured for beams corresponding to at least one of the at least one first beam set and the second beam set, and the transmission interval information represents at least one of: (i) a transmission interval of the at least one first beam set, (ii) a transmission interval of the second beam set, and (iii) a transmission interval between the at least one first beam set.

According to another aspect, the at least one first beam set includes a plurality of first beam sets, and a union of the plurality of first beam sets is included in or equal to the second beam set.

According to another aspect, the information for configuring the cell parameters includes information indicating application of overhead reduction using the AI/ML model.

According to another aspect, the at least one beam set includes a plurality of first beam sets associated with an input of the AI/ML model, and the information for configuring the cell parameters includes information indicating the number of the plurality of first beam sets.

According to another aspect, the at least one beam set includes at least one first beam set associated with an input of the AI/ML model, and the information for configuring the cell parameters includes information indicating the number of beams in each of the at least one first beam set.

According to another aspect, the information for configuring the cell parameters includes system frame number (SFN) information indicating the start of non-transmission of the at least one beam set and SFN information indicating the end of the non-transmission.

According to another aspect, beam reporting is performed based on at least one beam among the beams of the second beam set having the strongest received signal strength.

According to another aspect of the proposed invention, an operation method of a base station in a wireless communication system includes: transmitting information for configuring cell parameters; and transmitting at least one beam set associated with an AI/ML (artificial intelligence/machine learning) model based on the information for configuring the cell parameters. The information for configuring the cell parameters includes bitmap information and transmission interval information for the at least one beam set.

According to another aspect, the at least one beam set includes at least one first beam set associated with an input of the AI/ML model and at least one second beam set associated with an output of the AI/ML model.

According to another aspect, the bitmap information is configured for beams corresponding to at least one of the at least one first beam set and the second beam set, and the transmission interval information represents at least one of: (i) a transmission interval of the at least one first beam set, (ii) a transmission interval of the second beam set, and (iii) a transmission interval between the at least one first beam set.

According to another aspect, the at least one first beam set includes a plurality of first beam sets, and a union of the plurality of first beam sets is included in or equal to the second beam set.

According to another aspect, the information for configuring the cell parameters includes information indicating application of overhead reduction using the AI/ML model.

According to another aspect, the at least one beam set includes a plurality of first beam sets associated with an input of the AI/ML model, and the information for configuring the cell parameters includes information indicating the number of the plurality of first beam sets.

According to another aspect, the at least one beam set includes at least one first beam set associated with an input of the AI/ML model, and the information for configuring the cell parameters includes information indicating the number of beams in each of the at least one first beam set.

According to another aspect, the information for configuring the cell parameters includes system frame number (SFN) information indicating the start of non-transmission of the at least one beam set and SFN information indicating the end of the non-transmission.

According to another aspect, beam reporting is received based on at least one beam having the strongest received signal strength among the beams of the second beam set.

According to another aspect of the proposed invention, a terminal in a wireless communication system includes a transceiver configured to transmit and receive wireless signals, a memory configured to store instructions, and a processor operatively connected to the transceiver and the memory. Operations performed based on the execution of the instructions by the processor include: receiving information for configuring cell parameters; and acquiring at least one beam set associated with an AI/ML (artificial intelligence/machine learning) model based on the information for configuring the cell parameters. The information for configuring the cell parameters includes bitmap information and transmission interval information for the at least one beam set.

According to another aspect of the proposed invention, a base station in a wireless communication system includes a transceiver configured to transmit and receive wireless signals, a memory configured to store instructions, and a processor operatively connected to the transceiver and the memory. Operations performed based on the execution of the instructions by the processor include: transmitting information for configuring cell parameters; and transmitting at least one beam set associated with an AI/ML (artificial intelligence/machine learning) model based on the information for configuring the cell parameters. The information for configuring the cell parameters includes bitmap information and transmission interval information for the at least one beam set.

According to another aspect of the proposed invention, an operation method of a terminal in a wireless communication system includes: receiving system information; and receiving at least one beam set based on the received system information. When the at least one beam set is received during a first time interval and not received during a second time interval after the first time, at least one of (i) configuration information of a timer related to a radio link failure that is longer than the second time interval, and (ii) configuration information indicating a start point and an end point of the second time interval is acquired.

According to another aspect, the configuration information indicating the start point and the end point of the second time interval is acquired through the received system information using a system frame number (SFN).

According to the present invention, even when the overhead of a synchronization signal block (SSB) for beam sweeping is reduced by applying AI/ML-based beam prediction technology, performance degradation of existing user equipment (UE) can be minimized.

In particular, in the case of railways or automobiles, where the replacement cycle of UEs is long and safety-related information is handled, degradation of the performance of existing UEs must be minimized. Therefore, the present invention provides an essential technology for achieving such minimization.

### BRIEF DESCRIPTION OF THE DRAWINGS

FIG. 1 is a conceptual diagram illustrating a beam management method using AI/ML according to the related art.

FIG. 2A to 2C is a conceptual diagram illustrating the configuration of a beam set according to the related art.

FIG. 3 is a flowchart schematically illustrating a method for guaranteeing communication quality of an existing UE when applying AI/ML-based beam prediction according to an embodiment.

FIG. 4A to 4C is a conceptual diagram illustrating a beam set transmission method of BM-Case 1 in the method for guaranteeing communication quality of an existing UE when applying AI/ML-based beam prediction according to an embodiment.

FIG. 5A to 5C is a conceptual diagram illustrating a beam set transmission method of BM-Case 2-Case A in the method for guaranteeing communication quality of an existing UE when applying AI/ML-based beam prediction according to an embodiment.

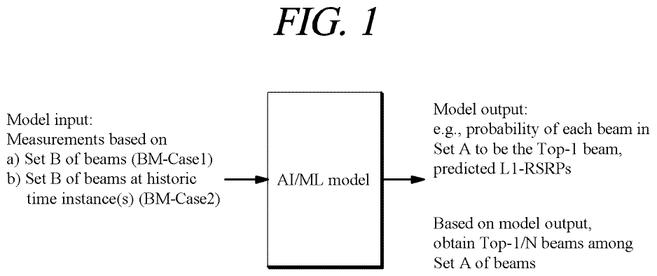

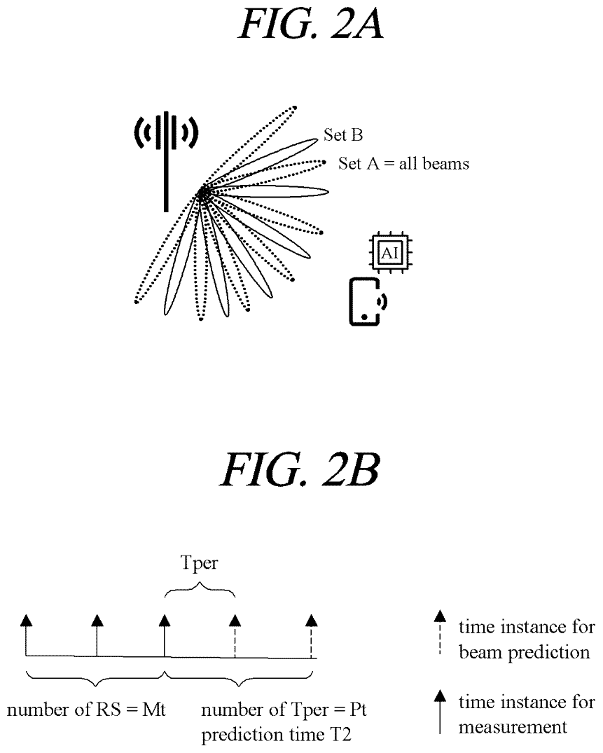

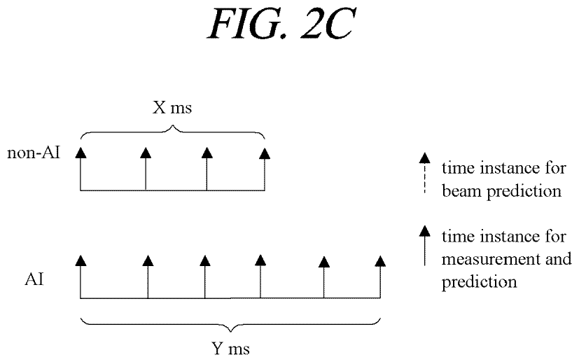

### DETAILED DESCRIPTION

The foregoing and additional aspects are embodied through embodiments described with reference to the accompanying drawings. It will be understood that components of the respective embodiments may be combined in various ways with components of other embodiments unless otherwise stated or mutually contradictory. Based on the principle that the inventor can appropriately define the concepts of terms to best describe the invention, the terms used in this specification and the claims shall be interpreted according to the meanings and concepts consistent with the descriptions and proposed technical ideas.

In this specification, a “module” or “unit” may include a processor and a memory storing a set of program instructions executable by the processor. The module or unit may also be implemented using a collection of electronic components or circuits such as an application specific integrated circuit (ASIC) or a field programmable gate array (FPGA) designed to perform such instructions. The operations of each module or unit may be executed by one or more processors or devices.

Components denoted by identical or similar reference numerals perform identical or similar functions, and therefore, redundant descriptions thereof may be omitted. For components having reference numerals whose descriptions are omitted, reference may be made to the components having identical or similar reference numerals.

Hereinafter, preferred embodiments of the present invention will be described in detail with reference to the accompanying drawings.

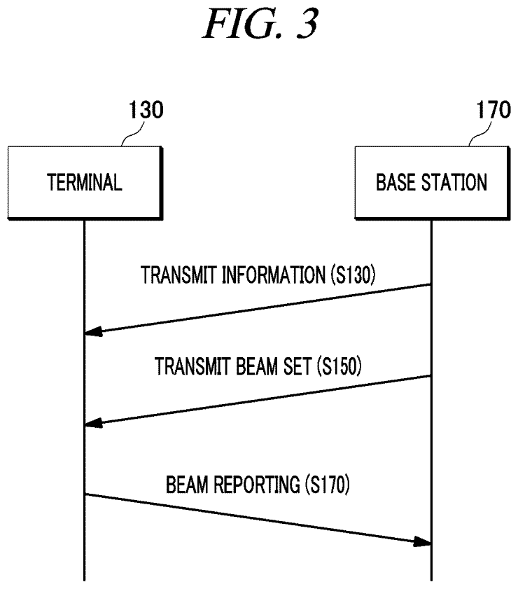

FIG. 3 is a flowchart schematically illustrating a method for guaranteeing communication quality of an existing UE when applying AI/ML-based beam prediction according to an embodiment.

According to an embodiment, a base station (170) of a wireless communication system transmits information for configuring cell parameters to a terminal (130) (S130). The terminal (130) receives the information for configuring cell parameters transmitted from the base station. The information for configuring the cell parameters includes bitmap information and transmission interval information for at least one beam set.

The base station (170) transmits at least one beam set associated with an AI/ML (artificial intelligence/machine learning) model to the terminal based on the information for configuring the cell parameters (S150). The terminal (130) acquires at least one beam set associated with the AI/ML model transmitted from the base station based on the information for configuring the cell parameters. The beam set may include a first beam set associated with an input and a second beam set associated with an output.

The terminal (130) performs beam reporting to the base station (170) (S170), and the base station (170) receives the beam report from the terminal. The beam reception report may be performed based on the beam having the strongest received signal strength among the beams of the second beam set associated with the output.

A more detailed configuration of the embodiment will now be described below.

In the present invention, to maintain the performance of existing user equipment (UE), the operation of the UE and the beam prediction-related information transmitted by the base station through radio resource control (RRC) are initiated.

In SystemInformationBlockType1 (SIB1) of the NR (New Radio) system, which is updated and transmitted at 160 ms intervals, ServingCellConfigCommonSIB is optionally included. ServingCellConfigCommonSIB includes ssb-PositionsInBurst and ssb-PeriodicityServingCell. The variable ssb-PositionsInBurst represents the types of beams transmitted in an SSB burst as a bitmap and consists of eight bits for FR1 (below 6 GHz) and an additional eight bits for FR2 (above 6 GHz). The variable ssb-PeriodicityServingCell represents the transmission periodicity of the SSB and may be selected from {ms5, ms10, ms20, ms40, ms80, ms160}.

When the AI/ML model is applied, the base station periodically transmits SSBs configured as Set B. In addition, the base station needs to transmit SSBs configured as Set A for model training and monitoring of AI/ML-supported UEs, as well as for existing UEs. In the present invention, an SSB burst configured with Set A is referred to as SSBs_A, and an SSB burst configured with Set B is referred to as SSBs_B.

Three types of UEs may simultaneously exist in the network: (i) an existing UE that does not support AI/ML, (ii) a new UE that does not support AI/ML, and (iii) an AI/ML-supported UE. When an AI/ML-non-supported UE exists, it is necessary to minimize the performance degradation of the AI/ML-non-supported UE caused by the application of AI/ML. In particular, when the AI/ML-non-supported UE is a safety-related UE, it is preferable that no performance degradation occurs, and even if degradation occurs, the safety UE must still be capable of receiving the required 5QI (5G QoS Indicator) service.

Table 1 is a table classifying UEs according to whether AI/ML support is provided.

TABLE 1

| Classification | Provided Capabilities | | |
|---|---|---|---|
| UE_a | AI/ML | New UE | Supports ServingCellConfigCommonSIB, |
| | supported | | Supports new RRC signaling for AI/ML-based beam |
| | | | prediction |
| UE_b | AI/ML | New UE | Supports ServingCellConfigCommonSIB, |
| | NOT | | Does not support new RRC signaling for AI/ML- |
| | supported | | based beam prediction |
| UE_c | | | Does not support ServingCellConfigCommonSIB, |
| | | | Does not support new RRC signaling for AI/ML- |
| | | | based beam prediction |
| UE_d | | Legacy | Supports ServingCellConfigCommonSIB |
| UE_e | | UE | Does not support ServingCellConfigCommonSIB |

### Signaling Related to the UE Operation in BM-Case 1.

When BM-Case 1 is applied, AI/ML-non-supported UEs can be further divided into UEs b/UEs d that support the ServingCellConfigCommonSIB option and UEs c/UEs e that do not.

Since UEs c and e cannot read the ServingCellConfigCommonSIB information, they perform beam selection using all SSBs transmitted by the base station. If the UEs c/e are in a connected state, the base station may instruct the UE to select the best beam through beam scanning when the base station transmits an SSB using Set A. To support this, the base station needs to periodically transmit SSBs_A.

However, when a UE performs beam scanning in an idle state, the UE is more likely to select a beam from Set B, which increases the probability that the UE will select an inappropriate beam, resulting in performance degradation. In severe cases, the UE may not even be able to attempt connection establishment until the base station transmits an SSB configured with Set A. Therefore, in order to reduce the time required for the UEs c/e to select an appropriate beam during the beam scanning process, a method may be applied in which multiple Sets B are generated and the union of the Sets B includes Set A. For example, the base station may alternately transmit Set B₁ and Set B₂ such that Set B₁∪Set B₂⊇Set A. Although the present invention mainly describes the case in which Set B₁ and Set B₂ are used, this method can be easily extended to a case including Set B₁, Set B₂, . . . , Set Bn.

Based on the above method, the base station may transmit Sets A and B according to the following three cases.

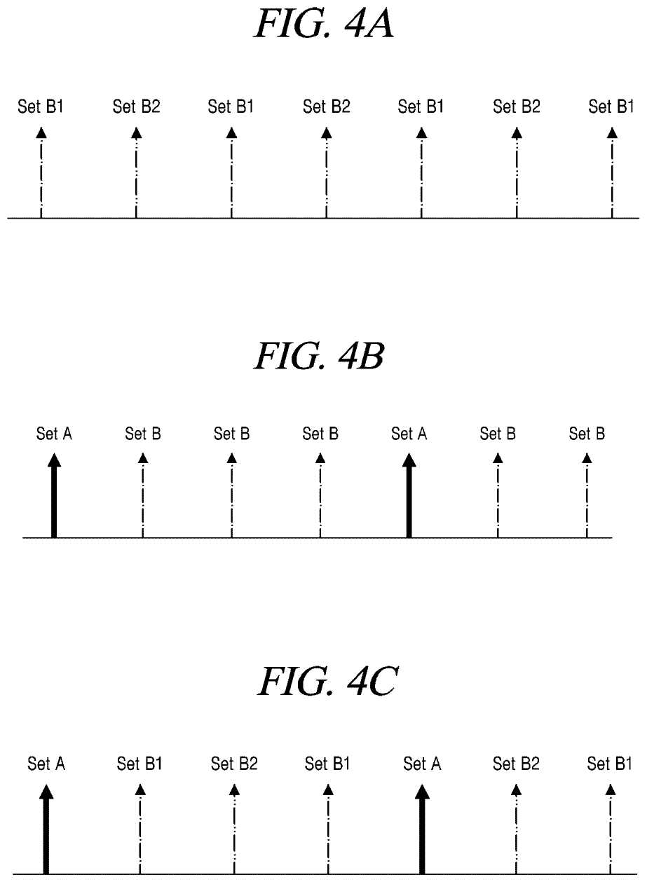

Case 1: The base station alternately transmits SSB_B₁ configured with Set B₁ and SSB_B₂ configured with Set B₂. FIG. 4A illustrates the SSB burst transmission period of Case 1.

Case 2: The base station transmits Set B while transmitting Set A at a longer period. When the transmission timings of Set B and Set A overlap, Set A is transmitted. FIG. 4B illustrates the transmission method of Sets A and B in Case 2.

Case 3: The base station alternately transmits Set B₁ and Set B₂ while transmitting Set A at a longer period. When the transmission timings of Set B₁/B₂ and Set A overlap, Set A is transmitted. If the transmission timing of Set B₂ overlaps with that of Set A, the base station transmits Set B₂ again in the next Set B transmission instead of Set B₁. FIG. 4C illustrates the transmission method of Sets A, B₁, and B₂ in Case 3.

FIG. 4A to 4C is a conceptual diagram illustrating a beam set transmission method of BM-Case 1 in the method for guaranteeing communication quality of an existing UE when applying AI/ML-based beam prediction according to an embodiment.

FIG. 4A illustrates the SSB burst transmission period of Case 1, FIG. 4B illustrates the transmission method of Sets A and B of Case 2, and FIG. 4C illustrates the transmission method of Sets A, B₁, and B₂ of Case 3.

When Case 1 is applied, an existing UE can select the optimal beam after receiving both the beams of Sets B and B₂, resulting in higher received signal strength (e.g., RSRP) compared to the conventional technology that transmits only Set B.

When Case 2 is applied, an existing UE performs beam scanning using Set A, which includes all beams, so that the UE can find the optimal beam at the same performance level as before. However, compared to Case 1, a larger number of resource blocks (RBs) are allocated for beam scanning.

Case 3 is a technique that maintains the beam-optimization performance of existing UEs while using an intermediate number of RBs between those of Case 1 and Case 2.

### 1.1 Signaling and Terminal Operation in BM-Case 1-Case 1

In Case 1, the operations of UEs a through e are as follows. UEs c and e perform beam scanning each time an SSB is transmitted, as in the conventional case. This is because both Set B₁ and Set B₂ are transmitted, allowing the UE to eventually find the optimal beam among all available beams over time.

UE d can identify part of the information on Sets B₁ and B₂ by using ssb-PositionsInBurst and ssb-PeriodicityServingCell included in the ServingCellConfigCommonSIB transmitted by the base station, and can act accordingly. To support this, the base station needs to set appropriate values for ssb-PositionsInBurst and ssb-PeriodicityServingCell. For example, the variables may be defined as shown in Table 2 below.

TABLE 2

```
(1) ssb-PeriodicityServingCell:
  Indicates the transmission interval between SSBs_B1 (Set
  B1) and SSBs_B2 (Set B2).
(2) ssb-PositionsInBurst:
Indicates the beams included in Set B1 ∪ Set B2.
```

When Set B₁∪Set B₂=Set A, the variable ssb-PositionsInBurst represents the beams of Set A. When Set B₁∪Set B₂⊂Set A, it represents a smaller subset of beams than those of Set A. However, when Set B₁∪Set B₂⊂Set A, the base station does not actually transmit an SSB burst configured with Set A; therefore, UE d does not need to know Set A.

Upon receiving such information, when UE d has received only the beams of SSBs_B₁, it can determine that not all beams indicated by ssb-PositionsInBurst have been transmitted. Based on this, UE d can perform additional beam scanning in the next period, and then transmit a PRACH or report measurement results to the base station.

UE a and UE b can identify the existence and transmission periods of Set B₁ and Set B₂ through newly defined RRC signaling. For example, new variables may be defined in the RRC signaling as shown in Table 3 below.

TABLE 3
(1) ssb-BeamReduction: Indicates whether AI/ML-based beam prediction is applied.
(2) ssb-ReducedBeamSet: Indicates the number of beams included in Set B.
(3) ssb-PositionInBurstA: Indicates the beams included in Set A.

By utilizing the above information, UE a may combine the measurement results of Set B₁ and Set B₂ to derive Set A, which can be used for the training and monitoring of AI/ML-based beam prediction. UE b may wait until all beams of Set B₁ and Set B₂ have been received, and then report the measured results to the base station or use them during the random access procedure.

The information contained in the RRC signaling defined for UEs a and b, and their corresponding operations, can be configured as described in the later embodiment section titled “3. Signaling and Terminal Operation in BM-Case 1-Case 1,” taking into account the previously defined ssb-PositionsInBurst and ssb-PeriodicityServingCell variables.

### 1.2 Signaling and Terminal Operation in BM-Case 1-Case 2

In Case 2, the operations of UEs a through e are as follows. UEs c and e perform beam scanning each time an SSB is transmitted. Accordingly, when Set B is transmitted, they may not be able to scan the optimal beam; however, when Set A is transmitted, they can find the optimal beam among all beams. When UEs c and e newly connect to any gNB, the gNB may instruct the UEs to perform beam scanning at the timing when Set A is transmitted.

UE d can identify part of the information on Sets B and A by using ssb-PositionsInBurst and ssb-PeriodicityServingCell included in the ServingCellConfigCommonSIB transmitted by the base station, and can act accordingly. To support this, RRC signaling may be defined as shown in Table 4 below.

TABLE 4
(1) ssb-PeriodicityServingCell: Indicates the transmission interval of SSBs_B.
(2) ssb-PositionsInBurst: Indicates the beams included in Set A.

When the RRC signaling is configured as described above, UE d can determine, using the information of ssb-PositionsInBurst, that not all beams indicated in ssb-PositionsInBurst have been transmitted if only the beams of Set B have been received. Accordingly, the UE may perform additional beam scanning until Set A is detected, and then transmit a PRACH or report measurement results to the gNB. This is because, when the transmission periods of Set B and Set A overlap, the base station transmits Set A, allowing the UE performing beam scanning at the period of SSBs_B to also perform beam scanning when SSBs_A is transmitted.

UE a and UE b can identify the transmission period of Set A and the beam configuration of Set B through newly defined RRC signaling. For example, new variables may be defined in the RRC signaling as shown in Table 5 below.

TABLE 5
(1) ssb-BeamReduction: Indicates whether AI/ML-based beam prediction is applied.
(2) ssb-PositionInBurstB: Indicates the beams included in Set B.
(3) Indicates the transmission periodicity of SSBs_A (Set A).

UE a and UE b can identify information regarding Sets A and B by combining the newly defined RRC signaling with the existing RRC signaling. The newly defined RRC signaling and corresponding UE operations can be configured as described in the later embodiment section titled “4. Signaling and Terminal Operation in BM-Case 1-Case 2.”

### Signaling and Terminal Operation in BM-Case 1-Case 3

In Case 3, the operations of UEs a through e are as follows. UEs c and e perform beam scanning each time an SSB is transmitted. Since both Set B₁ and Set B₂ are transmitted, the UE can eventually find the optimal beam among all beams over time, or when Set A is transmitted, the optimal beam can be found through a single beam scanning process.

UE d can identify part of the information of Sets B₁, B₂, and A by using ssb-PositionsInBurst and ssb-PeriodicityServingCell included in the ServingCellConfigCommonSIB transmitted by the base station, and can act accordingly. To support this, the base station may configure ssb-PositionsInBurst and ssb-PeriodicityServingCell as shown in Table 6 below.

TABLE 6
(1) ssb-PeriodicityServingCell: Indicates the transmission interval between SSBs_B1 and
SSBs_B2.
(2) ssb-PositionsInBurst: Indicates Set B1 ∪ Set B2 ∪ Set A.

When Set B₁∪Set B₂⊆Set A, the variable ssb-PositionsInBurst represents the beams of Set A. When Set B₁∪Set B₂⊃Set A, ssb-PositionsInBurst represents the beams of Set B₁∪Set B₂.

Upon receiving such information, when UE d has received only the beams of Set_B₁, it can determine that not all beams indicated by ssb-PositionsInBurst have been transmitted. Based on this, UE d can perform additional beam scanning in the next period and then transmit a PRACH or report measurement results to the gNB.

UE a and UE b can identify the existence and transmission periods of Sets B₁ and B₂ through the newly defined RRC signaling. Based on this, UE a may combine the measurement results of Sets B₁ and B₂ to derive Set A, which can be used for AI/ML-based beam prediction training and monitoring. UE b may wait until all beams of Sets B₁ and B₂ have been received, and then report the measured results to the base station or use them in the random access procedure.

The information of the RRC signaling defined for UEs a and b and their corresponding operations can be configured as described in the later embodiment section titled “5. Signaling and Terminal Operation in BM-Case 1-Case 3,” taking into account the previously defined ssb-PositionsInBurst and ssb-PeriodicityServingCell variables.

### Signaling and Terminal Operation in BM-Case 2

When BM-Case 2 is applied, as shown in Table 1, AI/ML-non-supported UEs can be further divided into UEs b/UEs d that support the ServingCellConfigCommonSIB option and UEs c/UEs e that do not. Therefore, it is basically possible to apply the Case 1/2/3 configurations of BM-Case 1 to BM-Case 2. However, in BM-Case 2, there exist a T₂ interval during which SSBs are not transmitted and a section where the transmission period increases to Y ms. Accordingly, additional signaling and terminal operations are defined for these conditions.

### 2.1 Signaling and Terminal Operation in BM-Case 2-Case A

In Case A, since the base station does not transmit SSBs during the T₂ interval, BM-Case 1-Case 1 to Case 3 may be applied as follows:

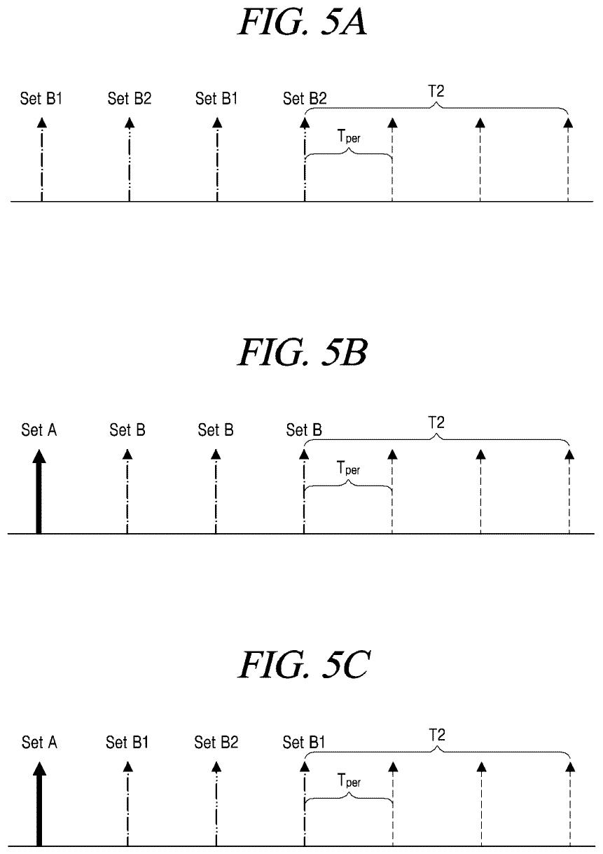

Case 1: The base station alternately transmits SSB_B₁ configured with Set B₁ and SSB_B₂ configured with Set B₂. Thereafter, the base station does not transmit SSBs for a duration of T₂. FIG. 5A illustrates the SSB burst transmission period of Case 1.

Case 2: The base station transmits Set B while transmitting Set A at a longer period. When the transmission timings of Set B and Set A overlap, Set A is transmitted. Thereafter, the base station does not transmit SSBs for a duration of T₂. FIG. 5B illustrates the transmission method of Sets A and B in Case 2.

Case 3: The base station alternately transmits Set B₁ and Set B₂ while transmitting Set A at a longer period. When the transmission timings of Set B₁/B₂ and Set A overlap, Set A is transmitted. If the transmission timing of Set B₂ overlaps with that of Set A, the base station transmits Set B₂ again in the next Set B transmission instead of Set B₁. Thereafter, the base station does not transmit SSBs for a duration of T₂. FIG. 5C illustrates the transmission method of Sets A, B₁, and B₂ in Case 3.

FIG. 5A to 5C is a conceptual diagram illustrating a beam set transmission method of BM-Case 2-Case A in the method for guaranteeing communication quality of an existing UE when applying AI/ML-based beam prediction according to an embodiment.

FIG. 5A illustrates the SSB burst transmission period of Case 1, FIG. 5B illustrates the transmission method of Sets A and B of Case 2, and FIG. 5C illustrates the transmission method of Sets A, B₁, and B₂ of Case 3.

UEs c and e cannot read the ServingCellConfigCommonSIB information; therefore, when the gNB does not transmit SSBs during T₂, these UEs may recognize the absence of nearby gNBs. To prevent radio link failure (RLF) caused by this, one or both of the following two methods may be applied:

Method 1: Configure the timer related to RLF determination to be longer than T₂.

Method 2: Notify the start and end times of T₂ using the system frame number (SFN) in the SIB.

In the embodiment of Method 1, the T310 timer, which operates when the terminal enters an out-of-sync state, is configured to be longer than T₂. For example, when T₂ is 80 ms, T310 may be set to a value of 100 ms or more, and when T₂ is 160 ms, T310 may be set to 200 ms or more.

If Method 1 is not applied, the terminal may declare an RLF (radio link failure) while the base station does not transmit SSBs. In such a case, the terminal attempts to reconnect to the base station, resulting in a period during which communication cannot be performed and transmission power consumption increases. By applying the embodiment of Method 1, such communication disconnection can be prevented by avoiding unnecessary RLF declarations. However, when T₂ is long, setting the RLF timer excessively long may delay recovery when an actual communication failure occurs.

In the embodiment of Method 2, the base station may inform the UE of the SFN (system frame number) at which T₂ starts and the SFN at which T₂ ends through SIB1.

Table 7 shows an example of RRC signaling configuration for BM-Case 2-Case A.

TABLE 7
ServingCellConfigCommonSIB ::= SEQUENCE {
...
ssb-VoidStart Bit STRING ( SIZE(10) ) //SFN at which T2 starts
ssb-VoidEnd Bit STRING ( SIZE(10) ) //SFN at which T2 ends and SSB
transmission resumes
...
}

Method 2, like Method 1, can also prevent the terminal from unnecessarily declaring an RLF. However, since the update cycle of the SFN (System Frame Number) information is very long, the period at which the base station changes T₂ must also be extended accordingly.

### 2.2 Signaling and Terminal Operation in BM-Case 2-Case B

In Case B, when the AI/ML model is not applied, the base station transmits SSBs at a period of X ms; when the AI/ML model is applied, the base station transmits SSBs at a period of Y ms. By substituting Y for the minimum SSB transmission interval of BM-Case 1, the configurations and principles of BM-Case 1-Cases 1 to 3 can be directly applied. For example, in BM-Case 1-Cases 1 to 3, ssb-PeriodicityServingCell corresponds to Y.

The embodiments of the present invention are described in further detail below.

### Signaling and Terminal Operation in BA-Case 1-Case 1

Three embodiments of BA-Case 1-Case 1 are presented: BA-Case 1-Case 1-1, BA-Case 1-Case 1-2, and BA-Case 1-Case 1-3.

### 3.1 Case 1-1

In this embodiment: ssb-PeriodicityServingCell transmitted by the base station indicates the transmission interval between SSBs_B₁ and SSBs_B₂. ssb-PositionsInBurst represents the combined beam set of Set B₁∪Set B₂. ssb-PositionsInBurstB₁ represents Set B₁ as a bitmap. ssb-PositionsInBurstB₂ represents Set B₂ as a bitmap.

In the following example, ssb-PositionsInBurstB is transmitted through ServingCellConfigCommonSIB, but it may also be transmitted via other RRC signaling messages. Moreover, although the following example describes a Standalone (SA) scenario, it can also be applied to a Non-Standalone (NSA) scenario.

Table 8 shows an example of RRC signaling for Case 1-1 configured with Sets B₁ and B₂.

```
TABLE 8
ServingCellConfigCommonSIB ::= SEQUENCE {
  ...
ssb-PositionsInBurst // Bitmap representing the beams of Set B1 ∪ Set B2
SEQUENCE {
  inOneGroup BIT STRING (SIZE (8)),
  groupPresence BIT STRING (SIZE (8)
},
ssb-PeriodicityServingCell, // Transmission interval between SSBs_B1
and SSBs_B2
ssb-BeamReductio n True or False,
// Indicates whether overhead reduction using AI/ML is applied.
ssb-ReducedBeamSet {n2,n3 }, // (Option0) Indicates the number of
beams in Set B
ssb-PositionsInBurstA //(Option1) Represents the beams of Set A in a
bitmap format
SEQUENCE {
    inOneGroup BIT STRING (SIZE (8)),
    groupPresence BIT STRING (SIZE (8))
},
ssb-PositionsInBurstB1 // Represents the beams of Set B1 in a bitmap
format
SEQUENCE {
    inOneGroup BIT STRING (SIZE (8)),
    groupPresence BIT STRING (SIZE (8))
},
ssb-PositionsInBurstB2 //(Option2) Represents the beams of Set B2 in a
bitmap format
SEQUENCE {
    inOneGroup BIT STRING (SIZE (8)),
    groupPresence BIT STRING (SIZE (8))
},
}
```

When the standard limits the number of Sets B to a maximum of two, the variable ssb-ReducedBeamSet under Option 0 may not be used.

If Set B₁∪Set B₂=Set A, there is no need for the base station to transmit separate information for Set A, and therefore, the variable ssb-PositionsInBurstA under Option 1 may not be used.

If Sets B₁ and B₂ have no overlapping beams, Option 2 may be omitted. In this case, the UE can identify the beams of Set B₂ by excluding ssb-PositionsInBurstB from ssb-PositionsInBurst. For instance, when Sets B₁, B₂, and B₃ are configured, ssb-PositionsInBurstB₁ and ssb-PositionsInBurstB₂ represent the beams of Sets B₁ and B₂, respectively, and the UE identifies the beams of Set B₃ by excluding ssb-PositionsInBurstB₁ and ssb-PositionsInBurstB₂ from ssb-PositionsInBurst.

### 3.2 Case 1-2

In this embodiment: ssb-PeriodicityServingCell indicates the transmission interval between SSBs_B₁ and SSBs_B₂. ssb-PositionsInBurst represents the combined beam set Set B₁∪Set B₂. ssb-ReducedBeamSet indicates the number of beams within Sets B₁, B₂, . . . , Bₓ.

In the following example, ssb-PositionsInBurstB is transmitted through ServingCellConfigCommonSIB, but it may also be transmitted via other RRC signaling messages. In addition, while the example below assumes a Standalone (SA) scenario, it can also be applied to a Non-Standalone (NSA) scenario.

Table 9 shows an example configuration of RRC signaling for Case 1-2, which consists of Sets B₁ and B₂.

```
TABLE 9
ServingCellConfigCommonSIB ::= SEQUENCE {
  ...
ssb-PositionsInBurst // Represents the beams of Set B1 ∪ Set B2 in a
bitmap format
SEQUENCE {
    inOneGroup BIT STRING (SIZE (8)),
    groupPresence BIT STRING (SIZE (8))
},
ssb-PeriodicityServingCell, // Transmission interval between SSBs_B1
and SSBs_B2
ssb-Beam Reduction True or False,
// Indicates whether overhead reduction using AI/ML is applied
ssb-ReducedBeamSet {nB1,nB2,...,nBx },
// Indicates the number of beams in Set B1, B2, ..., Bx
ssb-PositionsInBurstA //(Option1) Represents the beams of Set A in a
bitmap format
SEQUENCE {
    inOneGroup BIT STRING (SIZE (8)),
    groupPresence BIT STRING (SIZE (8))
},
}
```

In Case 1-2, if Set B₁∪Set B₂=Set A, there is no need for the base station to transmit separate information for Set A, and therefore, the variable ssb-PositionsInBurstA under Option 1 may not be used.

A UE that receives ssb-ReducedBeamSet can identify the beams of Set B₁ and Set B₂ through the following operation:

The UE treats the first nB₁ indices of ssb-PositionsInBurst as belonging to Set B₁, and the last nB₂ indices as belonging to Set B₂. If nB₁+nB₂ is greater than M=n (Set B₁∪Set B₂), then M_share=nB₁+nB₂−M represents the number of beams shared between Set B₁ and Set B₂.

When there are three or more Sets B, the UE distinguishes the beams of each set as follows. For example, when nB₁=nB₂=nB₃=nB₄=nB and 4nB>M=n (Set B₁∪Set B₂∪Set B₃∪Set B₄), M_share=(4nB−M)/4 represents the number of beams each Set shares with its adjacent Set. Specifically, M_share corresponds to: the number of beams shared between Set B₁ and Set B₂, the number of beams shared between Set B₂ and Set B₃, the number of beams shared between Set B₃ and Set B₄, and the number of beams shared between Set B₄ and Set B₁. Each beam's index is defined as follows in the subsequent example (see Table 10).
Set B₁={1, 2, . . . , nB}
Set B₂={nB−M_share+1, . . . , 2nB−M_share}
Set B₃={2(nB−M_share)+1, . . . , 3nB−2M_share}
Set B₄={mod(3(nB−M_share)+1, M), . . . , mod(4nB−3M_share, M)}

For example, when M=16 and nB=8, M_share becomes 2, and the beam indices of each Set are as follows:
Set B₁={1, 2, 3, 4, 5, 6}
Set B₂={5, 6, 7, 8, 9, 10}
Set B₃={9, 10, 11, 12, 13, 14}
Set B₄={13, 14, 15, 16, 1, 2}

If inOneGroup=1111 1111 and groupPresence=1100 0000, beam indices 1-8 correspond to groupPresence=1000 0000, and beam indices 9-16 correspond to groupPresence=0100 0000.

### Signaling and Terminal Operation in BA-Case 1-Case 2

In the following example, ssb-PositionsInBurstB transmitted by the base station is sent through ServingCellConfigCommonSIB, but it may also be transmitted via other RRC signaling messages. In addition, although the example below assumes a Standalone (SA) scenario, it can also be applied to a Non-Standalone (NSA) scenario.

Table 10 shows an example configuration of RRC signaling for Case 2.

```
TABLE 10
ServingCellConfigCommonSIB ::= SEQUENCE {
  ...
ssb-PositionsInBurst // Represents the beams of Set A in a bitmap format
SEQUENCE {
    inOneGroup BIT STRING (SIZE (8)),
    groupPresence BIT STRING (SIZE (8))
},
ssb-PeriodicityServingCell, // Transmission interval of Set B
ssb-BeamReduction True or False,
// Indicates whether overhead reduction using AI/ML is applied
ssb-PositionsInBurstB // Represents the beams of Set B in a bitmap format
SEQUENCE {
    inOneGroup BIT STRING (SIZE (8)),
    groupPresence BIT STRING (SIZE (8))
},
ssb-PeriodicityServingCellA // Transmission interval of Set A
}
```

In Case 2, when the transmission timings of ssb-PeriodicityServingCell and ssb-PeriodicityServingCell_A overlap, UEs UEₐ and UE_b determine that the beam of Set A has been transmitted and perform beam measurement and prediction-related operations accordingly. For example, if ssb-PeriodicityServingCell is 20 ms and ssb-PeriodicityServingCell_A is 80 ms, the fourth transmission period of the Set B beam coincides with the transmission period of the Set A beam. In this case, the UE regards the base station as having transmitted an SSB burst configured with Set A.

### Signaling and Terminal Operation in BA-Case 1-Case 3

Two embodiments, BA-Case 1-Case 3-1 and BA-Case 1-Case 3-2, are described below.

### 5.1 Case 3-1

In this embodiment: ssb-PeriodicityServingCell transmitted by the base station indicates the transmission interval between SSBs_B₁ and SSBs_B₂. ssb-PositionsInBurst represents the combined beam set Set B₁∪Set B₂∪Set A. ssb-PositionsInBurstB₁ represents Set B₁ as a bitmap. ssb-PositionsInBurstB₂ represents Set B₂ as a bitmap.

In the following example, ssb-PositionsInBurstB is transmitted through ServingCellConfigCommonSIB, but it may also be transmitted via other RRC signaling messages. Moreover, although the following example describes a Standalone (SA) scenario, it can also be applied to a Non-Standalone (NSA) scenario.

Table 11 shows an example configuration of RRC signaling for Case 3-1.

```
TABLE 11
// ssb-PeriodicityServingCell : Transmission interval between SSBs_B1
and SSBs_B2
// ssb-PositionsInBurst: Bitmap representing the beams of Set A
// ssb-PositionsInBurst_B: Bitmap representing the beams of Set B1
ServingCellConfigCommonS IB ::= SEQUENCE {
  ...
ssb-PositionsInBurst // Bitmap representing the beams of Set B1 ∪ Set
B2 ∪ Set A
SEQUENCE {
    inOneGroup BIT STRING (SIZE (8)),
    groupPresence BIT STRING (SIZE (8))
},
ssb-PeriodicityServingCell, //Transmission interval between SSBs_B1 and
SSBs_B2
ssb-BeamReduction True or False,
//Indicates whether overhead reduction using AI/ML is applied
ssb-ReducedBeamSet {n2,n3 }, //(Option0) Indicates the number of beams
in Set B
ssb-PositionsInBurstA //(Option1) Bitmap representing the beams of Set A
SEQUENCE {
    inOneGroup BIT STRING (SIZE (8)),
    groupPresence BIT STRING (SIZE (8))
},
ssb-PositionsInBurstB1 //Bitmap representing the beams of Set B1
SEQUENCE {
    inOneGroup BIT STRING (SIZE (8)),
    groupPresence BIT STRING (SIZE (8))
},
ssb-PositionsInBurstB2 //(Option2) Bitmap representing the beams of Set
B2
    SEQUENCE {
    inOneGroup BIT STRING (SIZE (8),
},
}
```

If the standard limits the number of Sets B to a maximum of two, the variable ssb-ReducedBeamSet under Option 0 may not be used.

If Set B₁∪Set B₂=Set A, there is no need for the base station to transmit separate information for Set A, and therefore, the variable ssb-PositionsInBurstA under Option 1 may not be used.

If Sets B₁ and B₂ have no overlapping beams and Set B₁∪Set B₂=Set A, Option 2 may be omitted. In this case, the UE identifies the beams of Set B₂ by excluding ssb-PositionsInBurstB from ssb-PositionsInBurst. When Sets B₁, B₂, and B₃ are configured, ssb-PositionsInBurstB₁ and ssb-PositionsInBurstB₂ represent the beams of Set B₁ and Set B₂, respectively, and the UE identifies the beams of Set B₃ by excluding ssb-PositionsInBurstB₁ and ssb-PositionsInBurstB₂ from ssb-PositionsInBurst.

### 5.2 Case 3-2

This configuration may be applied when Set B₁∪Set B₂=Set A. In this case: ssb-PeriodicityServingCell transmitted by the base station indicates the transmission interval between SSBs_B₁ and SSBs_B₂. ssb-PositionsInBurst represents Set A. ssb-ReducedBeamSet indicates the number of Sets B₁, B₂, . . . , Bₓ.

Table 12 shows an example configuration of RRC signaling for Case 3-2.

```
TABLE 12
ServingCellConfigCommonSIB ::= SEQUENCE {
  ...
ssb-PositionsInBurst //Bitmap representing the beams of Set A
SEQUENCE {
    inOneGroup BIT STRING (SIZE (8)),
    groupPresence BIT STRING (SIZE (8))
},
ssb-PeriodicityServingCell, //Transmission interval between Set B1_and
Set_B2
ssb-BeamReduction True or False,
//Indicates whether overhead reduction using AI/ML is applied
ssb-ReducedBeamSet {nB1,nB2,...,nBx}, //Indicates the number of beams
in Set B1, B2, ..., Bx
}
```

A UE that receives ssb-ReducedBeamSet can identify the beams of Set B₁ and Set B₂ through the following operation:

The UE regards the first nB₁ indices of ssb-PositionsInBurst as belonging to Set B₁, and the last nB₂ indices as belonging to Set B₂. If nB₁+nB₂ is greater than M=n (Set B₁∪Set B₂), M_share=nB₁+nB₂−M represents the number of beams shared between Set B₁ and Set B₂. When the number of Sets B is greater than two, the UE performs the same operation as described in Case 1-2.

Although the present invention has been described above with reference to embodiments illustrated in the accompanying drawings, it is not limited thereto, and it should be understood to encompass various modifications and alternative embodiments that can be easily conceived by those skilled in the art. The scope of the claims is intended to cover such variations and equivalents.

### MODE FOR CARRYING OUT THE INVENTION

The mode for carrying out the invention is substantially the same as the best mode described above.

### INDUSTRIAL APPLICABILITY

The present invention is applicable to technologies for ensuring the communication quality of user equipment (UE) when applying artificial intelligence (AI) and machine learning (ML)-based beam prediction, and thus has industrial applicability.

What is claimed is:

1. A method for operating a terminal in a wireless communication system, comprising:
receiving information for configuring cell parameters; and
acquiring at least one beam set associated with an AI/ML (artificial intelligence/machine learning) model based on the information for configuring the cell parameters,
wherein the information for configuring the cell parameters includes bitmap information and transmission interval information for the at least one beam set.

2. The method of claim 1,
wherein the at least one beam set includes at least one first beam set associated with an input of the AI/ML model and at least one second beam set associated with an output of the AI/ML model.

3. The method of claim 2,
wherein the bitmap information is configured for beams corresponding to at least one of the at least one first beam set and the second beam set, and
wherein the transmission interval information indicates at least one of
(i) a transmission interval of the at least one first beam set, (ii) a transmission interval of the second beam set, and (iii) a transmission interval between the at least one first beam set.

4. The method of claim 2,
wherein the at least one first beam set includes a plurality of first beam sets, and
a union of the plurality of first beam sets is included in or equal to the second beam set.

5. The method of claim 1,
wherein the information for configuring the cell parameters includes information indicating application of overhead reduction using the AI/ML model.

6. The method of claim 1,
wherein the at least one beam set includes a plurality of first beam sets associated with an input of the AI/ML model, and
the information for configuring the cell parameters includes information indicating the number of the plurality of first beam sets.

7. The method of claim 1,
wherein the at least one beam set includes at least one first beam set associated with an input of the AI/ML model, and
the information for configuring the cell parameters includes information indicating the number of beams of each of the at least one first beam set.

8. The method of claim 1,
wherein the information for configuring the cell parameters includes System Frame Number (SFN) information indicating a start of non-transmission of the at least one beam set and SFN information indicating an end of the non-transmission.

9. The method of claim 2,
wherein beam reporting is performed based on at least one beam having the highest received signal strength among beams of the second beam set.

10. A method for operating a base station in a wireless communication system, comprising:
transmitting information for configuring cell parameters; and
transmitting at least one beam et associated with an AI/ML (artificial intelligence/machine learning) model based on the information for configuring the cell parameters,
wherein the information for configuring the cell parameters includes bitmap information and transmission interval information for the at least one beam set.

11. The method of claim 10,
wherein the at least one beam set includes at least one first beam set associated with an input of the AI/ML model and at least one second beam set associated with an output of the AI/ML model.

12. The method of claim 11,
wherein the bitmap information is configured for beams corresponding to at least one of the at least one first beam set and the second beam set, and
wherein the transmission interval information indicates at least one of
(i) a transmission interval of the at least one first beam set, (ii) a transmission interval of the second beam set, and (iii) a transmission interval between the at least one first beam set.

13. The method of claim 11,
wherein the at least one first beam set includes a plurality of first beam sets, and
a union of the plurality of first beam sets is included in or equal to the second beam set.

14. The method of claim 10,
wherein the information for configuring the cell parameters includes information indicating application of overhead reduction using the AI/ML model.

15. The method of claim 10,
wherein the at least one beam set includes a plurality of first beam sets associated with an input of the AI/ML model, and
the information for configuring the cell parameters includes information indicating the number of the plurality of first beam sets.

16. The method of claim 10,
wherein the at least one beam set includes at least one first beam set associated with an input of the AI/ML model, and
the information for configuring the cell parameters includes information indicating the number of beams of each of the at least one first beam set.

17. The method of claim 10,
wherein the information for configuring the cell parameters includes System Frame Number (SFN) information indicating a start of non-transmission of the at least one beam set and SFN information indicating an end of the non-transmission.

18. The method of claim 11,
wherein beam reporting is received based on at least one beam having the highest received signal strength among beams of the second beam set.

19. A terminal in a wireless communication system, comprising:
a transceiver configured to transmit and receive wireless signals;
a memory configured to store instructions; and
a processor operatively connected to the transceiver and the memory,
wherein operations performed based on execution of the instructions by the processor include:
receiving information for configuring cell parameters; and
acquiring at least one beam set associated with an AI/ML (artificial intelligence/machine learning) model based on the information for configuring the cell parameters,
wherein the information for configuring the cell parameters includes bitmap information and transmission interval information for the at least one beam set.

20. A base station in a wireless communication system, comprising:
a transceiver configured to transmit and receive wireless signals;
a memory configured to store instructions; and
a processor operatively connected to the transceiver and the memory,
wherein operations performed based on execution of the instructions by the processor include:
transmitting information for configuring cell parameters; and
transmitting at least one beam set associated with an AI/ML (artificial intelligence/machine learning) model based on the information for configuring the cell parameters,
wherein the information for configuring the cell parameters includes bitmap information and transmission interval information for the at least one beam set.

21. A method for operating a terminal in a wireless communication system, comprising:
receiving system information; and
receiving at least one beam set based on the received system information,
wherein when the at least one beam set is received during a first time period and not received during a second time period after the first time period,
at least one of (i) configuration information indicating a timer associated with a radio link failure that is longer than the second time period, and (ii) configuration information indicating a start point and an end point of the second time period, is acquired.

22. The method of claim 21,
wherein the configuration information indicating the start point and the end point of the second time period is acquired through the received system information using a System Frame Number (SFN).
